(19) United States
(12) Patent Application Publication
(10) Pub. No.: US 2010/0278185 A1
(43) Pub. Date: Nov. 4, 2010

(54) METHOD FOR REDUCING THE REQUIRED MEMORY CAPACITY OF SWITCHES BY USING FICTIVE SOURCE MAC ADDRESSES

(76) Inventor: Ulf Järredal, Sundbyberg (SE)

Correspondence Address: ERICSSON INC., 6300 LEGACY DRIVE, M/S EVR 1-C-11, PLANO, TX, 75024, US

(21) Appl. No.: 12/743,085

(22) PCT Filed: Nov. 14, 2007
(86) PCT No.: PCT/SE2007/050846

§ 371 Date: Jul. 22, 2010

(51) Int. Cl. H04L 12/56

(52) U.S. Cl. 370/400

(57) ABSTRACT

The present invention relates to an access node for an access network. The access node is arranged to receive uplink data packets from a plurality of network devices. Each data packet comprises a source MAC address related to the network device being the source of the data packet. The access node is arranged to alter the source MAC address in the received uplink data packets to a fictive source MAC address common for at least a subset of said network devices. The present invention also relates to a method for controlling data packet traffic in an access node.

### TECHNICAL FIELD

The present invention relates to an access node for an access network. It also relates to a method for controlling data packet traffic in an access node in an access network.

### BACKGROUND ART

It is today common to build public or broadband networks in the Ethernet data link layer (second layer) of the OSI model. It is desirable to build as large Ethernet networks as possible. Thereby, the number of routers used for connecting Ethernet networks can be decreased. The routers are far more expensive than the Ethernet switches used for building the Ethernet networks. However, the Ethernet switches have some bottlenecks limiting the size of the networks that can be built using said switches. The most common problem for large Ethernet networks is the handling of MAC (Media Access Control) addresses of hosts connected to the network by means of the Ethernet switches.

An access network typically comprises said router, a plurality of hierarchical levels of Ethernet switches and an access node connected to each lowest hierarchical level Ethernet switch. Each access node has a plurality of ports each arranged to serve a host or a plurality of hosts via a home switch. Each Ethernet switch in said access network comprises a table comprising MAC addresses of hosts served by said Ethernet switch. When the number of hosts handled in the Ethernet layer of the network is increased, the size of the tables in the Ethernet switches also have to be increased. However, the memory capacity in the Ethernet switch for said table is limited and an expansion of the memory capacity involves high costs.

### SUMMARY OF THE INVENTION

It is one object of the present invention to enable solving or decreasing the problem discussed above in building access networks.

This has been achieved by modifying the access node so that it has a capability of altering the source MAC address in received uplink data packets to a fictive source MAC address common for at least a subset of source network devices.

Due to the fact that the access node is capable of altering the source MAC address to a fictive source MAC address common for a plurality of source network devices, uplink network devices (for example one or a plurality of Ethernet switches) experience a reduced number of MAC addresses served by that access node. Thereby, the memory capacity of upstream Ethernet switches can be reduced or the networks can be up scaled.

In an example, wherein all source MAC addresses in received uplink data packets are altered to the fictive source MAC address, the access node from the view of the upstream Ethernet switches is believed to be an endpoint (source or destination) for the data packets.

In one example, the access node comprises a memory with one record for each network device. Each record comprises the MAC address and an IP address for the network device to which the record relates. The memory with the records can be provided substantially without increasing the complexity of the access nodes at all, as the access nodes already have access to the IP addresses of the network devices handled by it. In one example, each record further comprises a port identity related to a port associated to the network device to which the record relates.

In one example, the access node is arranged to process received downlink data packets comprising information related to a destination IP address and information related to a destination MAC address in the following manner. The access node is arranged to associate received downlink data packets having a destination MAC address corresponding to the fictive MAC address to a record comprising the same IP address as the destination IP address of the received data packet, and to determine the destination as the MAC address of the record comprising the same IP address as the destination IP address of the received data packet

In one example, the access node is arranged to update the IP addresses of the records upon detection of allocation of a new IP address to any of the network devices

The present invention further relates to an access network, comprising at least one router arranged to interface a network layer network, at least one Ethernet switch connected to said router, and at least one access node according to the above having a first port connected to said Ethernet switch and a plurality of second ports each connectable to a network device, wherein the network devices are each associated to a unique MAC address.

The present invention also relates to a method for controlling data packet traffic in the access node described above.

### BRIEF DESCRIPTION OF THE DRAWINGS

FIG. 1 is a block scheme which schematically shows an example of an Ethernet network.

FIG. 2 is a block scheme which schematically shows an example of an access node in the network of FIG. 1.

FIG. 3 shows an example of a packet transported by the network of FIG. 1.

FIG. 4 is a flowchart showing an example of the operation of the access node in FIG. 2 in uplink communication.

FIG. 5 is a flowchart showing an example of the operation of the access node in FIG. 2 in downlink communication.

FIG. 6 shows an example of an amended uplink packet transported by the Ethernet network of FIG. 1.

### DETAILED DESCRIPTION

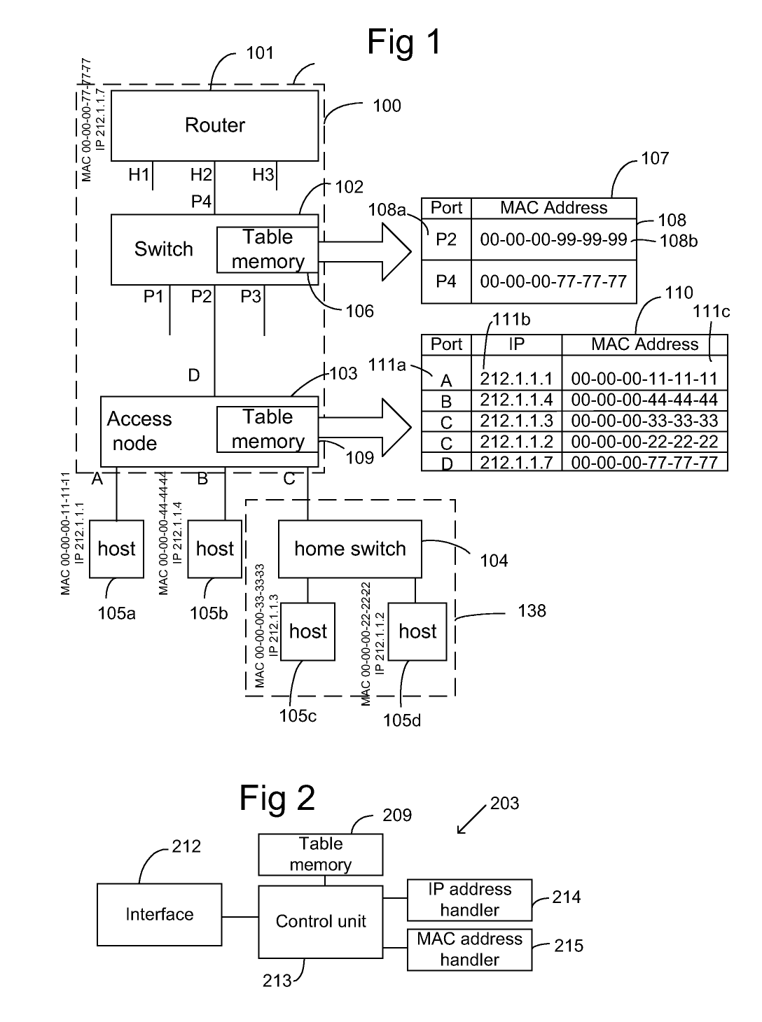

In FIG. 1, an access network 100 comprises a router 101, a plurality of layer two Ethernet switches 102 (of which one is actually depicted in the figure), and a plurality of access nodes 103 (of which one is actually depicted in the figure). Each access node 103 is in the shown example connected to a plurality of hosts or user network devices 105a, 105b, 105c, 105d. In the shown example, two of the hosts 105a, 105b are directly connected to the access node 103. A switch 104, for example in the form of a home switch used by a subscriber, connects the other two hosts 105c, 105d to the access node 103. The switch 104 and the hosts 105c, 105d served by said switch 104 form a home network 138. Thus, some of the hosts are directly connected to the access node while some of the hosts are comprised in home networks and connected to the access node via switches. The hosts 105a, 105b, 105c, 105d are for example personal computers and/or units for IP telephony. In a not shown example, all of the hosts are directly connected to the access node. In an alternative, not shown example, all hosts are connected to the access node via a respective switch.

The term layer two Ethernet switch above data refers to a switch operating in the data link layer (second layer) of the OSI model, wherein the data link network is Ethernet. The communication in Ethernet is based on addressing the network devices by means of Media Access Control addresses (MAC addresses). The MAC address is a quasi-unique identifier attached to each network device. The MAC address is for example attached to the network device by the manufacturer. In the illustrated example, the network devices having a MAC address are the hosts 105a, 105b, 105c, 105d and the router 101. The access node 103 is associated to a fictive MAC address, as will be described in detail below. We will herein use the term MAC address even though other addressing terms can be used. Accordingly, the term MAC address will herein include other address terms such as Ethernet hardware address, hardware address or adapter address.

The router 101 provides an interface to a network operating in the network layer (the third layer of the OSI model). In the network layer, addressing is provided by use of IP addresses. The router 101 will not be described in detail herein. It is only of interest that the router 101 is arranged to determine the proper path for data sent between different networks and to forward data packets to the next network device along this path. The router 101 is associated to a unique MAC address and to an IP address. The router 101 has a number of ports H1, H2, H3 interfacing the Ethernet. Each port is connectable to an Ethernet switch or other network device.

In the access network 100 shown in FIG. 1, the Ethernet switches 102 are connected to said router 101 via said ports H1, H2, H3. Further, each Ethernet switch 102 is provided with a number of ports, P1, P2, P3, P4. One of the ports P4 is connected to the router 101. The other ports P1, P2, P3 are each connectable another Ethernet switch, to an access node or other network device. The Ethernet switch 102 comprises a memory 106 for a table 107. The table 107 comprises the MAC address of the router to which it is operatively connected The table 107 further comprises the MAC addresses of the hosts 105a, 105b, 105c, 105d, which the Ethernet switch 102 handles. In said table 107, each MAC address is associated to a corresponding port P1, P2, P3, P4 of said network hub. Accordingly, each record 108 of the table 107 of the Ethernet switch 102 comprises a MAC address 108b and the identity of a port 108a to which the MAC address 108b is associated. The operation of the Ethernet switch for building up such a table based on information comprised in the data packets distributed by said Ethernet switch is well known in the art and does not need to be described in detail herein. The basic principle though, is that every time a host 105a, 105b, 105c, 105d (or router 101) having a new MAC address is operatively connected to the Ethernet switch 102, the Ethernet switch is arranged to learn the MAC address of the new host/router and the identity of the port to which the new host/router is associated. Further, if received downlink packets have a destination with unknown MAC address, the Ethernet switch is arranged to send the packet to all of its ports. However, it is only of interest herein that the Ethernet switches are arranged to learn where network devices are (i.e. to which port they are associated), by watching MAC addresses, and to build the table in accordance therewith. However, in building large Ethernet networks, there will be a large number of records 108 of the table of each Ethernet switch. Especially, in accordance with the conventional technique, there will be a large number of MAC addresses associated to each port. The table 107 in the Ethernet switch 102 has a limited size. If the table 107 becomes full and a new record is to be added, the oldest record in the table is in one example erased and replaced with the new record.

Each access node 103 of the access network 100 is connected to a higher level Ethernet switch 102 via one of its ports D. Further, each access node 103 has e plurality of ports A, B, C each connectable to a host 105a, 105b, 105c, 105d or a plurality of hosts via a switch 104. The switch 104 is for example a home switch associated to a subscriber. As stated earlier, each host 105a, 105b, 105c, 105d has a unique MAC address.

The hosts 105a, 105b, 105c, 105d are either assigned a static IP (Internet Provider) address or are allocated IP addresses dynamically. Either way, the access node 103 possesses information related to the IP address of the hosts 105a, 105b, 105c, 105d associated to it. In static allocation, the IP address of a given host 105a, 105b, 105c, 105d is configured in the access node 103. In this configuration, the IP address is assigned to that port of the access node 103, to which the host 105a, 105b, 105c, 105d having said IP address is associated. In dynamic allocation on the other hand, the access node 103 is arranged to supervise traffic through the access node 103 and to detect data packets containing information about assignment of a new IP address to one of the hosts 105a, 105b, 105c, 105d associated to it. The access node 103 is then arranged to assign the detected IP address to the port associated to that host. In dynamic allocation, allocation of an IP address is usually only valid for a given time period. However, the art of determining the IP addresses served by an access node 103 does not comprise part of the present invention. It is only assumed that the access node 103 has information related to the IP addresses of the hosts 105a, 105b, 105c, 105d associated to it. It is also assumed that the access node 103 has information related to the router 101 associated to it.

The access node 103 comprises a memory 109 for a table 110. The MAC addresses of the hosts 105a, 105b, 105c, 105d handled by said access node 103 is associated to a corresponding port of said access node. The table 110 at the access node comprises the MAC addresses of the hosts 105a, 105b, 105c, 105d, which the access node 103 handles. Accordingly, each record 111 of the table 110 of the access node 103 comprises a MAC address 111c and the identity of a port 111a to which the MAC address 111c is associated. The operation of the access node for building up such a table based on information comprised in the data packets distributed by said access node is equivalent to the operation of the above described Ethernet switch 102 and will not be described in further detail herein. It is only assumed that the access nodes 103 are arranged to learn where network devices (i.e. hosts and the router 101) are, by watching MAC addresses, and to build the table in accordance therewith.

Further, each IP address of the network devices (hosts and the router) served by the access node 103 is associated to a corresponding MAC address in said table. Accordingly, each record 111 of the table 110 of the access node 103 comprises a MAC address 111c. an IP address 111b and the identity of a port 111a to which the MAC address 111c is associated. The operation of the access node for determining the IP addresses of network devices (hosts and router) served by the access node was generally described above. The obtained IP address is then is correlated to the associated MAC address in the table. Further, the access node 103 is arranged to update the IP addresses of the table upon detection of allocation of a new IP address to any of the network devices.

In one example, each host is assigned to a unique MAC address and IP address. In another example, all hosts connected to the access node via one and the same switch 104 are all assigned to the same MAC address and IP address.

The access node 103 is arranged to perform a number of tasks other than those described above. In one example, the access node is arranged to provide bandwidth limitations to subscribers. In another example, the access node is arranged to provide a filter so that it is only possible for subscribers served by that node to use the IP addresses to which the subscribers have been allocated. The access node can also comprise other functions related to availability and security.

In FIG. 2, the access node 203 comprises an interface 212, a control unit 213, an IP address handler 214, a MAC address handler 215, and the table memory 209 as described above. The interface 212 comprises the ports A, B, C, described above, associated with the hosts 105a, 105b, 105c, 105d and the port D described above operatively connected to the router 101 via at least one Ethernet switch. The IP address handler 214 is arranged to determine the IP addresses of the hosts 105a, 105b, 105c, 105d and router 101 associated to it, as was described in relation to FIG. 1. The MAC address handler 215 is arranged to determine the MAC addresses of the hosts 105a, 105b, 105c, 105d, and router 101 associated to it, as was described in relation to FIG. 1. The control unit 213 is arranged to update the table memory 209 in accordance with the information provided by the MAC address handler 215 and the IP address handler 214. The control unit 213 is arranged to update the table 110 upon reception of information from the MAC address handler 215 that it has associated a MAC address to one of its ports. The control unit 213 is further arranged to associate an IP address 111b to a corresponding MAC address in the table 110 upon reception of information from the IP address handler 214 that it has associated an IP address to one of the MAC addresses handled by the access node 203. The control unit 213 is further arranged to control user traffic via the node, which shall be described in detail below.

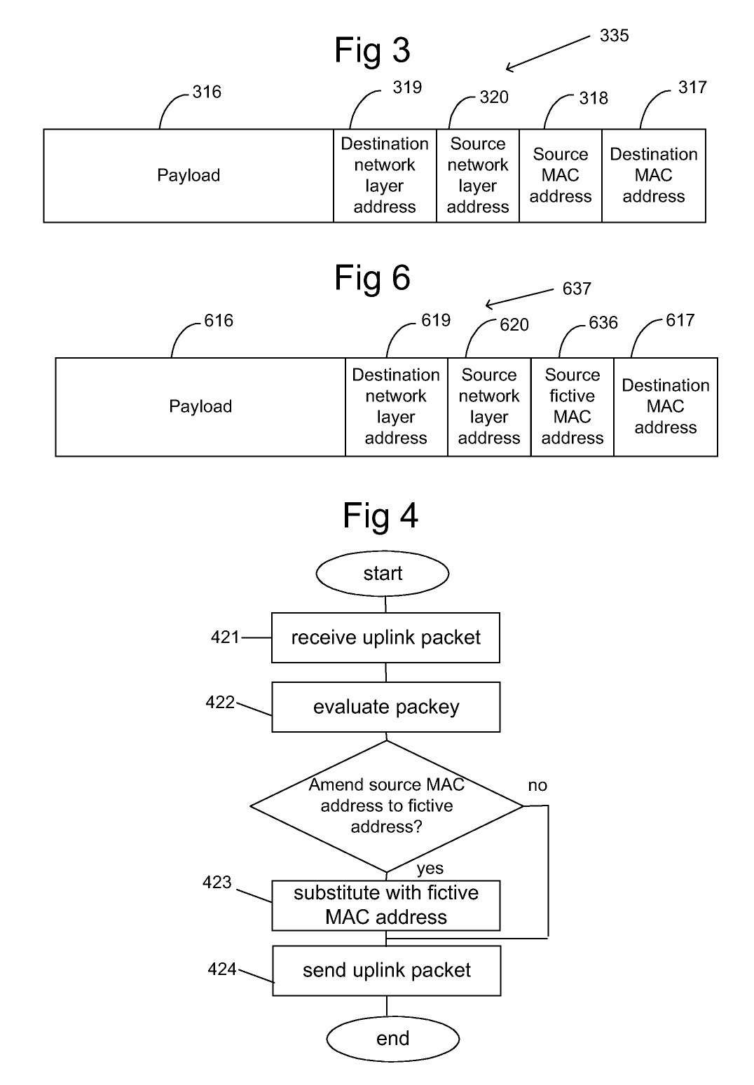

In FIG. 3, a user traffic message packet comprises a field for a destination MAC address 317, a field for a source MAC address 318, a field for a destination IP address 319, a field for a source IP address 320 and a field for payload information 316. Depending on the standard used for packet transportation, the address fields 317, 318, 319, 320 are either fields specified in the standard or fields comprised in the payload field 316. In one example, all address fields are designated in the standard used for packet transportation. In an alternative example, at least some of the address fields form part of the payload field 316. In the standard used to day, the fields for the destination MAC address 317 and source MAC address 318 are specified by the standard and the fields for the destination IP address 319 and source IP address 320 are comprised in the payload.

In FIG. 4, in uplink communication, the control unit 213 is arranged to receive an uplink user message packet in a step 421 originating from one of the hosts 105a, 105b, 105c, 105d. Accordingly, uplink communication is herein defined as communication in the direction from one of the hosts 105a, 105b, 105c, 105d to the router 101. The source MAC address information 318 in the received user traffic packet is substituted in a step 423 to a fictive MAC address associated to the access node in question. Thereafter, the amended uplink user message packet is sent in a step 424 further along its path via the Ethernet switch(es) 102 and the router 101 and to its destination. Thus, user traffic message packets originating from the hosts associated to the access node 103, are amended before further transmittal to its destination via the upstream Ethernet switch so that the user traffic packets from the access node 103 all comprise the same fictive source MAC address. The fictive MAC address is in one example manually configured in the access node. The fictive MAC address is in one example a private MAC address. In one example, the fictive MAC address is unique for that particular access node 103.

However, in the shown example, the MAC address is substituted for only a subset of the received uplink message packets. In accordance therewith, the received uplink user message packet is evaluated in a step 422 so as to determine if the source MAC address is to be substituted in the present user message packet. In one example the evaluation 422 comprises determining if the packet is a unicast packet. The packet is a unicast packet if it has a single destination. For example, the destination MAC address field 317 in the received uplink packet indicates if the destination is a unicast destination MAC address. If the packet is unicast, the control unit is arranged to substitute the source MAC address. If on the other hand, the packet is not unicast (e.g. multicast or broadcast), the control unit is not arranged to substitute the source MAC address. In an alternative or supplementary example, the control unit can be arranged to evaluate the source MAC address and to substitute the source MAC address for only packets fulfilling a predetermined criterion. For example, the MAC address can be substituted for those packets originating from a subset of hosts associated to the access node 103. Alternatively, the control unit can be arranged to evaluate for example from which port the received packets was received, in which case the control unit can be arranged to substitute the source MAC address for only those packets originating from a subset of ports. In yet another alternative example, the control unit can be arranged to evaluate the destination MAC address and to substitute the source MAC address for a subset of destination MAC addresses.

In FIG. 6, an amended user traffic message packet 637 comprises a field for the destination MAC address 617, a field for the fictive source MAC address 636, a field for the destination IP address 619, a field for the source IP address 620 and a field for payload information 616.

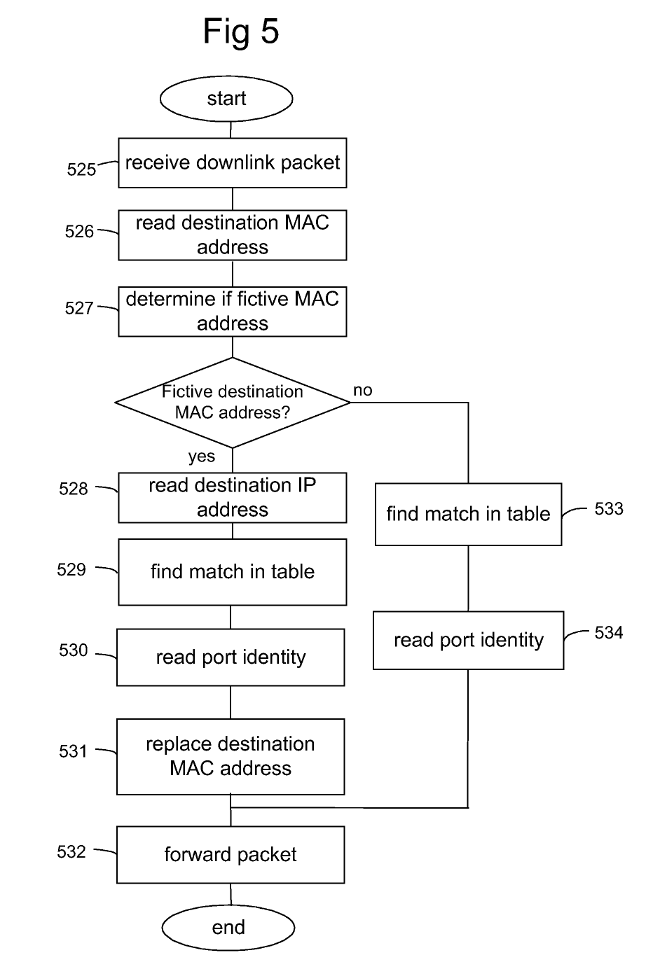

In FIG. 5, in downlink communication, the control unit 213 is arranged to receive a downlink packet in a step 525 from the Ethernet switch 102. Accordingly, downlink communication is herein defined as communication in the direction from the router 101 to one of the hosts 105a, 105b, 105c, 105d. The control unit 213 is further arranged to read in a step 526 the destination MAC address of user message packets received from the Ethernet switch 102 so as to determine if the destination MAC address is the fictive MAC address in a step 527. If the MAC address is the fictive address created by that access node, the control unit 213 is arranged to read also the destination IP address of the received packet in a step 528. The control unit 213 is then arranged to find that record 111 in the table 110 which is associated to the read IP address in a step 529. Information related to the identity of the port 111a to which the IP address is associated is read from that record 111 in a step 530. The control unit 213 is then arranged to forward the user message packet in a step 532 to that port of the access node 103, which was read out in the step 530. However, in the shown example, the control unit 213 is also arranged to amend the information in the received packet in a step 531 before forwarding it to the destination host in a step 532. The amendment comprises substituting the fictive destination MAC address of the received user message packet with the MAC address of the record associated to the destination IP address of the received user message packet.

If, on the other hand, the MAC address of the received downlink packet is not the fictive MAC address, the control unit 213 is then arranged to find that record 111 in the table 110 which is associated to the read MAC address in a step 533. Information related to the identity of the port 111a to which the MAC address is associated is read 534 from that record 111. The control unit 213 is then arranged to forward the user message packet in a step 532 to that port of the access node 103, which was read out in the step 534.

The example(s) described in relation to FIG. 5, relate to reception and processing of downlink unicast packets. If the received packets are broadcast or multipath packets, the processing described in relation to FIG. 5 can be superfluous, as the packets are sent to all hosts associated to the access node 103.

FIGS. 4 and 5 relates to an example wherein the access node is in part acting as a network device having a fictive MAC address and in part handling MAC addresses without acting as a network device having a fictive MAC address. In an example, wherein the access node wholly acts as a network device having a fictive MAC address, the operation of the access node can be simplified. For example, the step 422 of evaluating received uplink packets can be omitted. In correspondence thereto, the step 526 of reading the destination MAC address of the received downlink packets and the step 527 of determining if the MAC address is fictive can be omitted.

1. An access node for an access network, said access node receives uplink data packets from a plurality of network devices, each data packet comprising a source MAC address related to the network device being the source of the data packet, wherein the access node alters the source MAC address in the received uplink data packets to a fictive source MAC address common for at least a subset of said network devices.

2. The access node according to claim 1, comprising:
a memory with one record for each network device, each record further comprising the MAC address and an IP address for the network device to which the record relates.

3. The access node according to claim 2, wherein each record further comprises a port identity related to a port associated to the network device to which the record relates.

4. The access node according to claim 2, wherein the access node compares a destination IP address of a received downlink data packet with the IP addresses in the records to find a match and to determine the destination as the MAC address in the matching record.

5. The access node according to claim 2, wherein the access node updates the IP addresses of the table upon detection of allocation of a new IP address to any of the network devices.

6. An access network, comprising
at least one router to interface a network layer network,
at least one Ethernet switch connected to said router, and
at least one access node according to claim 1 having a first port connected to said Ethernet switch and a plurality of second ports each connectable to a network device, wherein the network devices are each associated to a unique MAC address.

7. A method for controlling data packet traffic in an access node of an access network, comprising:
receiving a uplink data packet, said data packet comprising MAC address information related to a source network device and information to a destination for said packet;
substituting the source MAC address in the in the received uplink data packet to a fictive source MAC address common for at least a subset of said network devices; and
sending the uplink data packet further along its path to its destination.

8. The method for controlling data packet traffic according to claim 7, further comprising:
recoding the MAC address of each source network device along with information related the identity of a port (A, B, C) associated to the corresponding MAC address and an IP address associated to the to the corresponding MAC address.

9. The method according to claim 8, further comprising:
receiving a downlink data packet comprising a destination IP address and destination MAC address informationd;
reading the destination IP address in the downlink data packet;
comparing the read destination IP address with the recorded IP addresses; and
sending the downlink data packet to that MAC address associated to the IP address matching the read destination IP address.

10. The method according to claim 8, further comprising
substituting the destination MAC address in the received downlink data packet with the MAC address associated to the IP address matching the read destination IP address.
